(19) United States
(12) Patent Application Publication
(10) Pub. No.: US 2023/0358202 A1
(43) Pub. Date: Nov. 9, 2023

(54) DEVICE FOR GENERATING ELECTRIC CURRENT IN A FLUID FLOW CIRCUIT

(71) Applicants: CENTRE NATIONAL DE LA RECHERCHE SCIENTIFIQUE, Paris (FR); INSTITUT POLYTECHNIQUE DE GRENOBLE, Grenoble (FR); UNIVERSITE GRENOBLE ALPES, Saint Martin D'heres (FR)

(72) Inventors: Stéphane BARRE, Gap (FR); Antoine DELON, Chorges (FR)

(21) Appl. No.: 18/245,068

(22) PCT Filed: Sep. 15, 2021
(86) PCT No.: PCT/EP2021/075298

§ 371 Date: Mar. 13, 2023

(30) Foreign Application Priority Data
Sep. 16, 2020 (FR) 2009393

(51) Int. Cl. F03B 13/08; H02K 7/08; H02K 7/18

(52) U.S. Cl. CPC F03B 13/08; H02K 7/083; H02K 7/1823; F05B 2240/244; F05B 2260/404

(57) ABSTRACT

-- A device for generating electric current in a fluid flow circuit, including a duct segment interposed in the fluid flow circuit, a rotor mounted in the duct segment and movable by the passage of a fluid through the device, and a stator or stator circuit cooperating with the rotor and producing electric current. The rotor is made up of a transverse flow turbine, the axis of rotation of which extends across the duct segment, the turbine having at the longitudinal ends of its axis of rotation means for holding against the opposite walls of the duct segment, the stator or stator circuit being positioned outside the duct segment at an end of the turbine which is able to be driven in rotation while the turbine moves, and includes structure for generating a magnetic flux for cooperating with the stator or stator circuit in order to produce the electric current.

The invention is situated in the field of generating electric current by means of a fluid (preferably liquid) flowing within a pipe or mains.

This electric current generation, more particularly pico-generation of electric current, is carried out by means of a transverse axis hydraulic machine intended to produce energy for supplying sensors (or other systems) in areas that have no connection to the power grid. In particular, the application of this invention is envisaged in the context of the power supply to sensors for monitoring drinking water supply networks.

### DESCRIPTION OF THE PRIOR ART

Generating electricity by means of hydraulic turbine engines is an old technology dating back more than one hundred years. Among all the types of turbines used up to the present, there are two major categories: impulse turbines and reaction turbines.

Impulse turbines act mainly by deflecting a jet of liquid onto a wheel with adapted geometry. The most common models of impulse turbines are the Pelton type and the Banki type turbines. These machines all have in common the use of a chamber at atmospheric pressure (thus in contact with the ambient air) to perform the interaction between the liquid jet and the driving wheel.

Reaction turbines act mainly by using the lift generated on their blades to create a driving torque. Consequently, these machines are completely submerged within the fluid from which they extract energy.

The most widely-used turbines are the axial machines (of the helical or Kaplan type) and the turbines with centripetal effect (Francis type). If it is proposed to generate energy by “inserting” a hydraulic turbine engine within a drinking water distribution network, care must be taken that it has only a marginal effect on the hydraulic and mechanical characteristics of this network. It is thus almost impossible to envisage the use of impulse turbines for such applications. In fact, in that case, it would be impossible to maintain the hydraulic continuity of the support pipeline. In particular, it would be necessary to have an area of contact with the air in order to operate the turbine therein. This could only be performed by drawing off a small part of the flow in order to allow its pressure to drop in said turbine. This flow, used in this way, will be lost to the mains in question, as it has been depressurized to atmospheric pressure after passing through the turbine. Therefore, only reaction turbines can be used for such an application.

Thus, within the family of the different turbines that can be used for the application envisaged, it is noted that two main solutions coexist. On the one hand, there are the machines that will be installed upstream of a bend in the pipeline to make it possible for a shaft to come out of the pipeline itself. Thus, the shaft will serve to drive the electricity generator which by virtue of this configuration can be situated outside the pipeline and thus be located in the open air. On the other hand, machines also exist for which the electricity generator is mounted within the pipe in a watertight casing (known as bulb unit technology). These two approaches are in general use in all hydroelectric power plants worldwide. Both have their advantages and their drawbacks and their use depends on the technology of the turbine used, and at the same time, on the specific configuration of the installation in question.

However, if their use is considered in the context of a pico-generation device installed on a hydraulic circuit (for example in a drinking water network), all of these devices share major drawbacks that are set out below. Firstly, there is a problem associated with watertightness. Thus, regardless of the chosen configuration (installation upstream of the bend with the generator in the open air or “bulb” assembly with the generator submerged in a watertight casing) it is necessary to ensure perfect watertightness of the transmission shaft situated between the turbine and the electricity generator, whether it is submerged in the flow or situated outside the pipe.

The document CN-A-111396231 thus proposes a device comprising a turbine mounted in a conduit, this turbine comprising an axis of rotation associated with a generator also engaged in the conduit. The conduit thus comprises an orifice in which a ring bearing the generator is engaged in the orifice to allow the rotation of the turbine to be transmitted directly to the generator. With such an installation, a risk arises with respect to the degree of watertightness of the generator on the pipe.

In the documents US-A-2010/0253031, CN-A-105443298 and CN-A-111005833, the devices described have an axis of rotation that passes through the wall of the conduit from one side to the other, and are thus connected with an external generator. There again, watertightness can pose a problem as time goes by.

The document US-B-10233898 describes a device for generating energy interposed in a toilet conduit. This device comprises a portion of conduit in which a turbine is mounted, the rotation shaft of which bears a support for magnets that generate a magnetic flux. This magnetic flux cooperates with magnetic means of a stator or stator circuit to produce an electric current. The portion of conduit is shaped to exhibit the form of a casing in which the turbine, the means for generating a magnetic flux, and the stator are mounted. Such a device has the drawback of being provided on a conduit for the water supply to the toilet cistern in which a small volume of water flows and cannot be suitable for a pipe of a drinking water supply network. In addition, in the event of breakdown, the entire device must be removed, causing an unacceptable stoppage in the supply network.

Moreover, in the context of use on a supporting pipe of a water distribution network, without resorting to a bypass system, it is impossible to evacuate high flow rates without producing significant pressure loss. This aspect of things makes using such turbines difficult (whether they are axial or centripetal) in the application on a pipe of hydraulic networks (in the case of drinking water networks for example).

In addition, these devices give rise to geometrical complexity and require high standards with respect to mechanical construction quality. In fact, if axial or centripetal hydraulic turbines are used, in order to obtain good yields it is necessary to use vanes which have relatively complex geometrical characteristics and are therefore difficult to manufacture economically.

Geometries of the machines described in the documents FR-A-3010150, US-A-2012007364, US-A-2010148515 and WO-A-2005080790, are also known, which are of the axial type and thus have recourse to quite complex blade shapes. It is also noted that in particular, the machine described in patent application WO-A-2005080790 has vane rows that are static but adjustable upstream of the turbine, which although it allows its yield to be increased, otherwise makes its construction more complex, thus increasing the cost. This adjustment function is performed by means of variable-incidence vanes in the context of the turbine shown in the patent US-A-2010148515. This solution produces a turbine of great complexity, which constitutes a defect when a robust, reliable machine is sought with a low construction cost.

Another problem consists of the space requirement of the turbine and of its supports within the encasing pipeline. For all of the machines shown in the various documents mentioned above, it so happens that they all have in common the fact of being axial. For them to function correctly, it is therefore necessary for their axis of rotation to be strictly parallel to the axis of fluid flow. Therefore accurate positioning of this axis of rotation involves inserting a whole assembly of support and guidance parts into the fluid pipe.

In addition to making the machine more complicated and more expensive, this whole assembly will produce high parasitic pressure losses right at the centre of the pipe, which are detrimental to obtaining usable power levels for very low fluid speed values (of the order of 0.5 m/s cut-in speed) while maintaining the lowest possible pressure loss level during these sequences of low-speed production with the aim of avoiding imbalance in the hydraulic network (for example of drinking water) from which energy is drawn.

Furthermore, the positioning of the electricity generation stator or stator circuit on the periphery gives rise to another problem arising from the fact that all the machines described in the documents mentioned above are axial and that the electricity generation stator circuit is situated all round the periphery of the turbine and thus of the pipeline itself. Therefore, the devices described in these documents do not use a conventional electricity generator on these very low-power turbines intended to be incorporated into pipes. This choice allows the problem to be greatly simplified, since there is thus in principle no need to manage the problem of watertightness on the transmission shaft. However, the other aspect of this choice is that it will prove necessary on these axial machines to install an electricity generation system on the periphery of the blades and thus also of the pipeline. In particular, on the machines described in the patents FR3010150A1, US2012007364A1 and W02005080790A1, it is proposed to install permanent magnets on the periphery of the blades. These magnets thus create a fluctuating magnetic field through the walls of the pipeline so as to induce a current in the stator circuit installed over the entire circumference of the tubing and which is as a result firmly fixed thereto.

Such a choice poses many technical problems that are difficult to solve. Indeed, the fact of arranging magnets at the periphery of the turbine vanes will generate significant centrifugal forces (as a result of the relatively high weight of these magnets), and in addition requires very strict dynamic balancing of the turbine due to the presence of significant weights at the end of the blades. Moreover, this strategy involves surrounding the entire pipe with inductor coils or magnetic circuits so as to create, on the periphery of the pipe, a synchronous machine with a high number of poles specific to the pipeline and the turbine used. It is therefore not possible to make use of a standard synchronous machine that is commercially available and mass-produced so as to drastically reduce this cost item.

It also proves to be the case that in this configuration in which the current is generated at the periphery of the turbine, it will be necessary for the air gap between the end of the blades and the pipeline to be as small and as regular as possible. This precaution is essential to minimize the losses of magnetic flux between the turbine and the stator circuit situated on the outer periphery of the pipe. In fact, such losses could result in a severe drop in the mechanical-to-electrical conversion yield of the generator. This obligation will therefore impose a very strict manufacturing constraint with respect to the tolerance associated with obtaining a perfectly constant figure for the dimension of the air gap and especially for compliance therewith regardless of the operational conditions of the machine. This constraint results in a significant increase in the complexity of manufacture of the machine and therefore inflates its cost.

It is probable that the fluid which passes into the turbine may contain foreign bodies and the risk that these may contaminate the air gap is not insignificant. This situation may result in malfunctions, illustrating a lack of ruggedness of this concept in relation to the quality of the fluid acting on the turbine. There may in particular be a risk of deterioration of the magnets, which are particularly exposed to this concern due to their installation at the periphery of the vanes of the turbine.

Thus, in the documents FR-A-3010150 and WO-A-2005080790, in order to protect these magnets, it has been proposed to install them in annular-type cavities around the periphery of the wheel, so as to protect it from any foreign bodies present in the fluid. However, with such an approach, the magnets are in motion at a very high relative speed in relation to the fluid imprisoned in this protective cavity. Thus, due to the small size of said cavity, the emergence of a turbulent Couette flow will take place, which will generate high hydrodynamic losses by friction at the level of the magnets and thus reduce the overall yield of the machine. In addition, due to the recirculation phenomenon, the fluid in contact with the magnets is semi-enclosed in this protective cavity. Thus, the level of convection is very low inside the cavity and therefore very little mass and energy is exchanged with the external fluid flowing in the pipe. This situation, which accumulates the hydrodynamic losses resulting from the turbulent Couette flow as well as the electromagnetic losses in the air gap in an area where the fluid can exchange only very little mass and energy with the outside, will lead to heating of the air gap, which at the same time will have an effect on the magnets and above all on the stator circuit situated around the entire periphery of the pipe.

Thus, with this axial machine design, it proves very difficult to properly cool the module for converting mechanical energy to electrical energy. It follows that there is an operational limit, which is very rapidly reached if the temperature increases too much, in particular at the level of the magnets.

Taking account of the drawbacks mentioned relating to the state of the art and the technology currently in use, the present invention proposes to overcome said drawbacks by proposing a device for generating energy the simple architecture and implementation of which allow it to be robust and economically beneficial.

To this end, a purpose of the present invention is to propose a device for generating an electric current in a fluid flow circuit, comprising: a conduit segment, intended to be interposed in the fluid flow circuit, a rotor mounted in the conduit segment and suitable for being moved by the passage of a fluid in said device and a stator or stator circuit arranged to cooperate with the rotor and produce the electric current, characterized in that the rotor is constituted by a cross-flow turbine the axis of rotation of which extends across the conduit segment, the turbine comprising at the longitudinal ends of its rotation shaft, means for holding against the opposite walls of the conduit segment, the stator or stator circuit being positioned outside the conduit segment at the level of one end of the turbine which can be driven in rotation during the movement of the turbine, and comprises means for generating a magnetic flux in order to cooperate with said stator or stator circuit to produce the electric current.

Thus, advantageously, only the rotor is installed in the conduit segment, which simplifies the construction of the device and even more advantageously, the longitudinal ends of the axis of rotation of the turbine are mounted between the opposite walls of the conduit, and in abutment against them, so that the technical solution proposed by the present invention does not involve any watertightness system. In fact, the proposed turbine is inserted naturally into a conduit segment, the ends of which are configured to constitute a piece of standard pipeline of a flow circuit having any cross section whatever.

The cross-flow or transverse-flow turbine is a turbine provided with a vertical axis of rotation about which blades are driven in rotation, the current flow arriving perpendicularly to this axis.

The turbine thus has at the longitudinal ends of its axis of rotation, bearing assemblies with ball bearings, said bearing assemblies being mounted in housings arranged on the conduit segment to hold the transverse-flow turbine in the conduit segment and allow the rotation of the turbine. These ball bearings are preferably ceramic, and therefore, furthermore, need neither watertightness means nor lubrication means.

Preferably, the turbine is constituted by two hubs, preferably in the form of a disk, either flat or dome-shaped, between which extend blades, preferably two, which can be driven in rotation under the effect of the flow of a fluid in the conduit.

Each hub has a bearing assembly at its centre and bears means for generating a magnetic flux, such as permanent magnets. Preferably, one or both hubs are equipped with permanent magnets over the whole of their circumference. Thus, the mechanical power generated by the driving of the blades in rotation about the axis of rotation of the turbine by the current flow in the conduit is transferred to the outside of the conduit by means of a magnetic field created by the permanent magnets borne by the hub also driven in rotation. There is thus no need to provide a mechanical transmission system to outside the pipeline and as a result, no watertightness device is necessary. This characteristic makes it possible to propose a device that is at the same time simple, robust and economical.

According to an embodiment of the turbine, its axis of rotation is constituted by a shaft extending between the hubs.

According to another embodiment, the axis of rotation of the turbine is constituted by the two bearing assemblies only. Thus, advantageously, the axis of rotation has no physical expression between the two hubs, which thus causes almost no pressure loss, even for very high flow speeds.

Preferably, the two blades extend between the hubs symmetrically with respect to the axis of rotation of the turbine and the central part of said blades can be driven in rotation, sweeping a surface inscribed within a cylinder of revolution about the axis of rotation.

Advantageously, the driving torque of this turbine is transmitted to the outside of the pipeline by means of the action of a magnetic field through the wall of the conduit segment and to the extent that the turbine is supported on two bearing assemblies with ball bearings, the latter are immersed in the fluid and the device therefore needs neither watertightness nor lubrication. This assembly is thus easily compatible with the hygiene standards associated with turbine use in drinking water. In fact there are many standards for equipment in contact with drinking water (food standards), for example the French standard XP P41-280 from the circular DGS/SD7A N°571 of 25 Nov. 2002. The main technical constraints involved in compliance with these standards in fact consist of avoiding all watertightness and/or lubrication systems so as not to risk external contamination of the water at the level of the machine, and then to use materials authorized for contact with food, such as for example ceramics, food grade stainless steel, etc. The device according to the invention thus makes it possible to comply advantageously with these requirements.

The device according to the invention can be incorporated within a fluid flow circuit, in particular of liquid, comprising conduits the cross section of which can be circular, but also square, rectangular or any polygon. Moreover, the device according to the invention can have a very small size. It can thus be installed on drinking water mains having diameters comprised between 100 and 200 mm.

The device according to the invention thus makes it possible to pick up the torque of the turbine, on the outside of the conduit, by means of one or more stator circuits installed at the level of the magnetic hub or hubs located facing the inside of this conduit itself.

According to a first embodiment, the stator or stator circuit also constitutes the electricity generator.

According to a second embodiment, the stator circuit comprises one or more magnetic coupler elements that can be driven in rotation and allow the direct mechanical drive of one or more conventional electricity generators.

According to a third embodiment, the stator circuit comprises one or more magnetic multiplier/ coupler assemblies allowing the mechanical drive of one or more mass-produced electricity generators.

Advantageously, the transfer surface of the power of the flow in the direction of the outside of the conduit or pipeline thus only corresponds to a small angular sector of the conduit and therefore does not need the use of the entire peripheral surface of said conduit for the entire transmission of the turbine torque in magnetic form, which makes it possible to simplify the architecture of this device and limit its space requirement on the pipeline. The technology proposed here is simple, rugged and therefore robust.

In fact, in the case of devices with axial machines, it is necessary to provide an electricity generation device installed on the periphery of the vanes. Therefore, the induced stator circuit occupies the entire periphery of the support pipe. This leads to inflexibility in the architecture of the machine, since this stator circuit must be made to measure, and therefore is difficult to standardize, which makes it difficult to obtain a substantial reduction in the costs.

In the device according to the present invention, a stator circuit attached to a lateral bracket of the conduit is used. It is thus possible to use magnetic circuits with very simple geometry, which can be easily standardized. In addition, if a magnetic coupler element or even a magnetic multiplier/coupler element is used, then low-priced, high-performance standard electricity generators can be used, all without significant loss in power transmission.

The device according to the invention also has an architecture with which there is no risk of pollution of the electromagnetic air gap by a foreign body present in the fluid, since here, the magnetic flux is transmitted through the wall of the conduit in an area of very limited extent, which is protected from the main flow. Also advantageously, there is no longer a risk of heating of the stator circuit, since it is outside the conduit and can thus easily be equipped with a finned radiator that will be more than sufficient to dissipate the few watts of heat loss occurring in the context of use of the device according to the invention for powering sensors along a drinking water supply circuit.

Very advantageously, in the event of the occurrence of high flow rates in the flow circuit in which a device according to the invention is installed, the latter comprises means for immobilizing the turbine with its blades oriented in the direction of the current flow. In this position, the turbine, preferably two-blade with transverse axis of rotation which has no physical expression between the two hubs according to one of the embodiments, offers only a very low drag, and causes almost no pressure loss, even for very high flow speeds. It is thus possible to dispense with a bypass system when using a device according to the invention. The device, as well as its command and control system, are thus greatly simplified, which leads to a reduction in cost and an increase in reliability.

In particular, the circumstances are avoided where, in the event of an emergency causing high flow rates in the flow circuit, for example in the case of pipeline breakage on the hydraulic network downstream of the turbine or also during use of a fire hydrant, very high flow speeds endanger the mechanical integrity of the turbine.

In addition, the need to provide a bypass system is thus avoided, which would itself be necessary in the case of use of an axial flow turbine. In fact, in the case of an axial flow turbine, once stopped, it represents much too great a pressure loss to be able to correctly ensure this relief function. Moreover, as it is difficult to arrange for them to withstand such speeds without being obliged to over dimension them, there will then be a risk of making them almost inoperable (or producing very low yields) when used at a very low flow speed (of the order of 0.5 m/s), which actually constitutes normal use.

According to another advantage of a device according to the invention, the transversal-axis turbine used in the context of the present invention makes it possible to use identical symmetrical hydraulic profiles over the whole length of a blade. Furthermore, it is possible to use blades the chord of which is constant over the whole length and which thus have no twist. Therefore, the manufacture can be extremely simplified with respect to the blades of axial machines, which need for example a three-dimensional blade geometry that is complex to produce, in that most frequently the hydrodynamic profile develops between the root and the end of the blade. In particular, blade profiles can be produced by pultrusion of composite materials, then next, bending them to obtain a circular shape. It is also possible to use a die to extrude a base profile from food grade stainless steel, then bend to the desired circular shape. All these methods are economic and allow manufacture in small or large quantity at low cost.

In addition, horizontal-axis turbines need systems with bearing assemblies and supports in the middle of the pipe in order to be able to provide the function of guiding the turbine wheel. On the other hand, the transversal-axis turbine used in the present invention does not need a support structure in the centre of the pipeline, which makes it possible to drastically simplify the device. Indeed, no fixed structure will partially obstruct the fluid stream within the conduit, unlike the axial machines. As a result, parasitic pressure loss is much smaller and therefore there is less turbulence on the network from which energy is drawn.

Advantageously, the device according to the invention can be used for the pico-generation of electrical energy in order to supply electrical appliances such as monitoring sensors on fluid flow circuits such as drinking water networks. In fact, it is possible that in the short term legislation will require all drinking water networks to be equipped with a very dense mesh of monitoring sensors in order to determine the flow rates of leaks and also to monitor certain chemical parameters of the water, such as in particular the presence of toxic products in the water that may occur either accidentally or following malicious action. The device according to the invention thus offers a simple and efficient solution for supplying these sensors.

In addition, it is noted that in most of the places where these sensors are installed, or can be installed, it is not always simple and economical to connect to the power grid in order to power these sensors.

The solution currently employed by the operators is thus to use batteries, the lifetime of which is comprised between 1 and 3 years. For example a sensor is known under the trade name VEOLIA KAPTA 3000-AC4 which is supplied by batteries. Such a solution for battery electrical power supply therefore remains the most used, as the sensors are still not very numerous on the networks and the operators are not yet required to finance the recycling of the used batteries.

However, as already mentioned, with the arrival of the new European regulations associated with the monitoring of the drinking water networks, it will be necessary to install thousands of sensors to comply with the required mesh density. Therefore, the solutions based on batteries will become too expensive both in terms of purchase and recycling costs, and also in terms of additional maintenance costs if it is necessary to intervene very regularly to change the batteries on the thousands of sensors that will be in service on the networks.

The implementation of electrical energy generation devices according to the invention in drinking water distribution networks makes it possible to supply the sensors with energy in a reliable, robust and economical manner.

The present invention also relates to a fluid flow circuit comprising at least one electrical appliance such as a sensor, characterized in that said circuit comprises a device for generating electrical energy according to the invention incorporated in the circuit, intended to supply the sensor with electrical energy.

A subject of the present invention is also a cross-flow turbine, comprising two blades extending between two hubs aligned on the axis of rotation, the central part of said blades being capable of being driven in rotation, sweeping a surface inscribed within a cylinder of revolution about the axis of rotation, characterized in that each hub is presented in the form of a flat or domed disk driven in rotation by the blades, at least one of its hubs comprising means generating a magnetic flux, holding means aligned on the axis of rotation being borne by each hub. Such a turbine can advantageously be used in a device according to the invention.

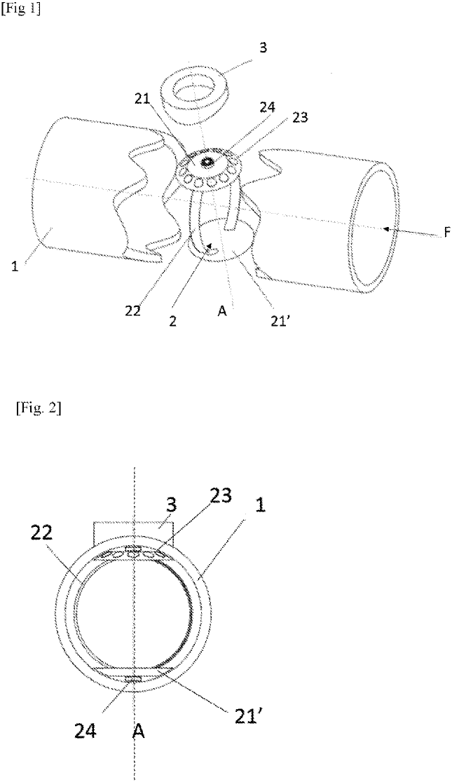

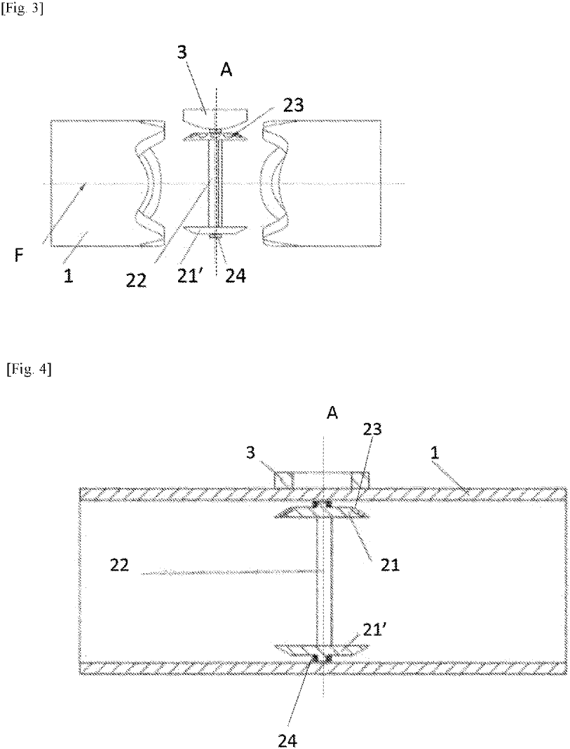

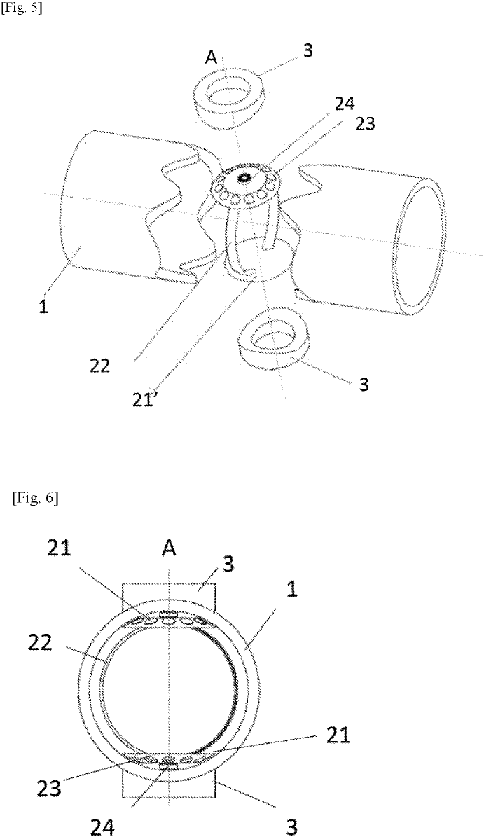

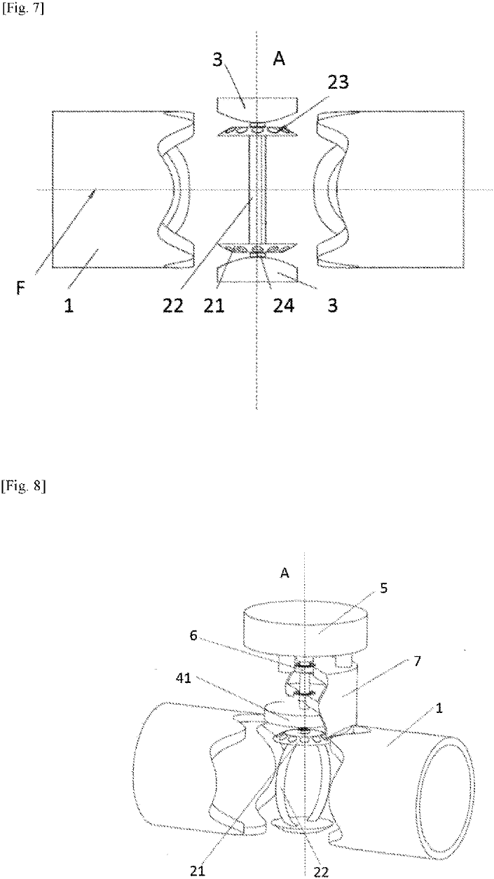

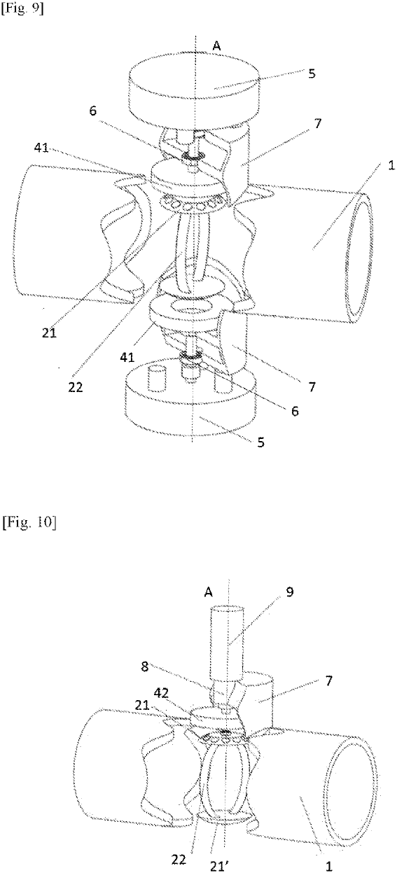

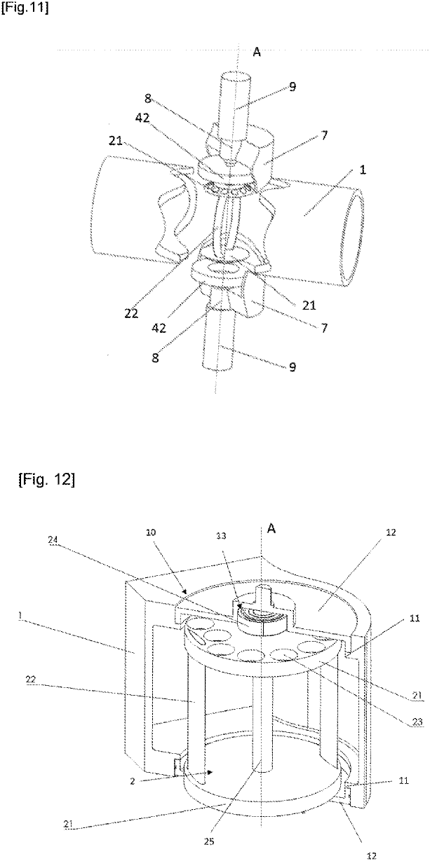

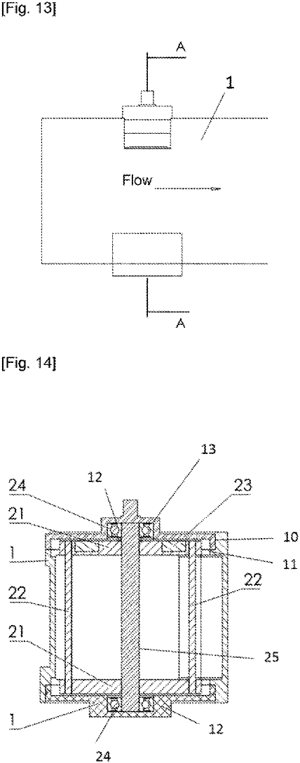

A description of the invention will now be given in greater detail with reference to the figures, which represent:

[FIG. 1] an exploded perspective top view of a first embodiment of a device according to the invention;

[FIG. 2] a perspective front view of the embodiment in FIG. 1;

[FIG. 3] a perspective side view of the device in FIG. 1;

[FIG. 4] a longitudinal cross section view along the cut plane A-A in FIG. 2;

[FIG. 5] an exploded perspective top view of a variant of the device in FIG. 1;

[FIG. 6] a perspective front view of the embodiment in FIG. 5;

[FIG. 7] a perspective side view of the device in FIG. 5;

[FIG. 8] an exploded perspective top view of a second embodiment of the invention;

[FIG. 9] an exploded perspective top view of a variant of the device in FIG. 8;

[FIG. 10] an exploded perspective top view of a third embodiment of the invention; and

[FIG. 11] an exploded perspective top view of a variant of the device in FIG. 10;

[FIG. 12] an exploded perspective view of another embodiment of a device according to the invention;

[FIG. 13] a perspective side view of the device in FIG. 12; and

[FIG. 14] a cross section view along the cut line A-A in FIG. 13.

The device for generating electric current according to the invention comprises a conduit segment 1 in which is mounted a rotor 2. A stator 3 is installed at the outer periphery of the conduit 1 to cooperate with the rotor 2.

The rotor 2 is constituted by a cross-flow turbine installed in the conduit segment 1 such that the axis of rotation A of the turbine 2 extends transversally in the conduit segment 1. This circular-section turbine 2 has two blades 22 and has a transversal axis.

This turbine 2 is constituted by two hubs 21 between which extend the blades 22, preferably two. These blades 22 are mounted symmetrically with respect to the axis of rotation A of the turbine 2 and mobile in rotation about the axis A under the effect of a fluid flow F flowing in the conduit 1.

In movement, the blades 22 sweep a surface inscribed within a cylinder of revolution about the axis A.

Each blade 22 extends between the hubs 21 along a curve substantially following the circular cross section of the conduit, but any type of blades originating from transverse-flow turbines can be used, provided that the central part of the blade sweeps a cylinder of revolution. The shape of the blades can also be a U-shape, or any suitable shape. Preferably, the blade ends are fixed to the hubs. Preferably, the blades 22 of the turbine are produced by pultrusion of composite materials then bent to obtain a circular cross section. In particular, they can be produced from food grade stainless steel, extruded in a die then bent to obtain a circular cross section.

Each hub 21, 21′ is presented in the form of a domed disk in the shape of a cup or dome as shown in FIG. 1, or flat as shown in FIG. 12, driven in rotation by the blades 22. One of the hubs 21 contains permanent magnets 23 placed so as to be positioned facing the wall of the conduit segment 1. The variable magnetic flux is transmitted through the wall of the conduit 1 and induces, within the coils of the stator circuit 3 positioned on the outside of the conduit 1 opposite this end of the turbine 2, an electric current that is then exploited.

The second hub 21′ has no permanent magnets in this example.

A variant of this first embodiment is shown in FIG. 5 in which, for applications for which it is required to transmit a higher torque, a second hub 21 is used, bearing magnets 23, and placed opposite the first on the conduit 1. By virtue of this device, it is possible to double the torque that can be transmitted.

The two-bladed transversal-axis turbine 2 is thus intended to form an integral part of a conduit of any cross section (circular as shown in the figures but also, square, rectangular or any polygon) in which a fluid, in particular liquid, flows.

This turbine 2 is held in the conduit by two bearing assemblies 24 arranged at the centre of the hubs in the form of a domed disk 21. These two bearing assemblies 24 hold the turbine against the opposite walls of the conduit segment 1, these bearing assemblies preferably being lodged in housings arranged for this purpose in the wall of the conduit segment 1 so that the axis of rotation A of the turbine is orthogonal to the axis of the current flow of the fluid F. Thus, holding the turbine 2 in the conduit segment 1 in this way needs neither watertightness nor lubrication. The power of the turbine 2 is transmitted to the outside of the conduit by means of a magnetic device using one or more hubs equipped with permanent magnets over the whole of its circumference. As can be seen in FIGS. 12 and 14, the conduit segment 1 can comprise housings 13 in which the bearing assemblies 24 are mounted. The hubs 21 are mounted capable of being driven in rotation about the bearing assemblies 24.

The surface of transfer of this power in the direction of the outside of the conduit segment 1 only corresponds to a small angular sector of said conduit segment and does not in any way need the use of the entire peripheral surface of said conduit segment for the entire transmission of the turbine torque in magnetic form.

FIGS. 8 and 9 show a device according to the invention in which the turbine 2 of the same type as those in the preceding figures in which a magnet-carrier element 4 for transmitting the mechanical torque of the turbine is installed on the outside of the conduit. This magnet-carrier element 4 can thus be firmly fixed to a standard mass-produced electricity generator 5 (of the synchronous type with a radial-flux permanent magnet for example).

Thus, under the effect of the fluid flow F, the blades 22 are driven in rotation, driving in rotation the hub 21 bearing the magnets 23. The magnet-carrier 41 placed opposite is also driven in rotation. This magnet-carrier element 41 is connected by a shaft 6 to a generator 5. The magnet-carrier element 41/shaft 6 assembly is enclosed in a casing 7.

FIG. 9 shows a variant comprising a second generator, for applications needing high torques.

Such an embodiment thus provides both a very low resale price as well as very good yields. It is also notable that this embodiment can also be combined with a pipe having a square or rectangular cross section so as to limit the air gap between the two magnetic supports, inner (hub) and outer (magnet-carrier element), and thus allow effective transmission.

FIGS. 10 and 11 show an embodiment of the device of the invention in which an outer magnetized coupler element 42 is used in combination with a magnetic multiplier 8 as a stator circuit so as to increase the rotation speed of the output shaft in order to be able to use a permanent-magnet synchronous generator 9 with a high rotation speed.

Thus excellent (mechanical-to-electrical) conversion yields are obtained while still using low-cost, high-performance generators. In addition, the magnetic multiplier causes almost no loss, and can become very economic to produce provided that a sufficient number are constructed. It is also notable that this embodiment can also be combined with a pipe having a square or rectangular cross section so as to limit the air gap between the two magnetic turrets, inner and outer, and thus allow effective transmission of the torque to the outside.

In the examples shown above, the axis of rotation A of the turbine 2 is constituted only by the bearing assemblies 24 around which the hubs 21 bearing the blades 22 are driven in rotation.

FIGS. 12 to 14 show an embodiment example of the device according to the invention, in which a shaft 25 extends centrally between the two hubs 21 thus constituting the axis of rotation A extending transversally in the conduit segment 1.

As can be seen in FIGS. 12 and 14, the conduit segment 1 is shaped to have within these opposite walls, two orifices 11 in which are lodged the ends of the turbine 2, held in place by two end plates 12.

The hubs 21 are here constituted by two flat disks having, at least for one, magnets 23 at its periphery. Each hub 21 has at its centre a bearing assembly 24 as well as a shaft 25 extending between the two hubs 21 and constituting the axis of rotation A of the turbine. An end plate 12 is attached on each hub 21 and comprises a housing 13 in which a bearing assembly 24 is positioned and one end of the rotation shaft 25 of the turbine 2. The bearing assembly 24 is mounted fixed in the housing 13 of the conduit segment 1 and the shaft 25 is rotational and firmly fixed to the hubs 21. Thus a device is obtained that is simple to implement, the simple structure of which also confers great robustness thereto. The blades 22 extend diametrically opposite to one another on one side and on the other side of the axis of rotation A between the hubs 21, with their ends connected to the hubs 21.

1. A device for generating electric current in a fluid flow circuit, comprising:
a conduit segment, intended to be interposed in the fluid flow circuits;
a rotor mounted in the conduit segment and suitable to be moved by the passage of a fluid in said device; and
a stator or a stator circuit arranged to cooperate with the rotor and produce the electric currents;
the rotor is constituted by a cross-flow turbine, the axis of rotation of which extends across the conduit segment, the turbine comprising at the longitudinal ends of its axis of rotation, means (24) for holding against the opposite walls of the conduit segment; the stator or stator circuit being positioned outside the conduit segment at the level of one end of the turbine which can be driven in rotation during the movement of the turbine, and comprises means for generating a magnetic flux in order to cooperate with said stator or stator circuit to produce the electric current.

2. The device according to claim 1, characterized in that the turbine has at the longitudinal ends of its axis of rotation bearing assemblies with ball bearings, said bearing assemblies being mounted in housings arranged on the conduit segment to hold the turbine transversally in the conduit segment and allow the rotation of the turbine.

3. The device according to claim 2, characterized in that the ball bearings are ceramic.

4. The device according to claim 2, characterized in that the turbine is constituted by two hubs between which extend blades, preferably two, capable of being driven in rotation under the effect of the flow of a fluid in the conduit, each hub having a bearing assembly and at least one of the hubs bearing the means of generating a magnetic flux.

5. The device according to claim 4, characterized in that the means for generating a magnetic flux are permanent magnets.

6. The device according to claim 4, characterized in that each blade extends between the hubs, the central part of a blade sweeping a cylinder of revolution about the axis of rotation.

7. The device according to claim 6, characterized in that the blades of the turbine are produced by pultrusion of composite materials then bent.

8. The device according to claim 6, characterized in that the blades of the turbine are produced from food grade stainless steel extruded through a die then bent.

9. The device according to claim 4, characterized in that at least one said hub is constituted by a flat disk.

10. The device according to claim 4, characterized in that aat least one said hub is constituted by a domed-shaped disk.

11. The device according to claim 4, characterized in that the axis of rotation (A) of the turbine is constituted by a shaft extending between the hubs.

12. The device according to claim 4, characterized in that the axis of rotation (A) of the turbine is constituted only by the two bearing assemblies.

13. The device according to claim 1, characterized in that the stator or stator circuit also constitutes the electricity generator.

14. The device according to claim 1, characterized in that the stator or stator circuit comprises one or more magnetic coupler elements that can be driven in rotation, allowing the direct mechanical drive of one or more electricity generators.

15. The device according to claim 1, characterized in that the stator or stator circuit comprises one or more magnetic multiplier/coupler elements allowing the mechanical drive of one or more electricity generators.

16. The device according to claim 1, characterized in that the ends of the conduit segment are provided with means of fastening in the fluid flow circuit.

17. A fluid flow circuit comprising at least one electrical appliance such as a sensor, characterized in that said circuit comprises a device for generating electrical energy according to claim 1, incorporated in the circuit, and intended to supply the electrical appliance with electrical energy.

18. A cross-flow turbine, comprising two blades extending between two hubs aligned on the axis of rotation (A), the central part of said blades being capable of being driven in rotation, sweeping a surface inscribed within a cylinder of revolution about the axis of rotation (A), intended to be used in a device according to claim 1, characterized in that each hub is presented in the form of a flat or domed disk driven in rotation by the blades, at least one of its hubs comprising means for generating a magnetic flux, holding means aligned on the axis of rotation (A) being borne by each hub.
